(19) United States
(12) Patent Application Publication
(10) Pub. No.: US 2025/0305555 A1
(43) Pub. Date: Oct. 2, 2025

(54) SYSTEM AND METHOD FOR CONTROL OF REVERSAL EVENTS USING MAGNETORHEOLOGICAL FLUID

(71) Applicant: EXONETIK INC., Sherbrooke (CA)

(72) Inventors: Patrick CHOUINARD, Sherbrooke (CA); Pascal LAROSE, Sherbrooke (CA); Jean-Sébastien PLANTE, Sherbrooke (CA)

(21) Appl. No.: 18/863,214

(22) PCT Filed: May 15, 2023
(86) PCT No.: PCT/CA2023/050663

§ 371 Date: Nov. 5, 2024

Related U.S. Application Data
(60) Provisional application No. 63/341,501, filed on May 13, 2022.

(51) Int. Cl. F16F 15/03; B60R 16/023; F16D 35/02

(52) U.S. Cl. CPC F16F 15/03; B60R 16/0231; F16D 35/02; F16F 2222/06; F16F 2224/045; F16F 2230/18

(57) ABSTRACT

A system for operating a magnetorherological (MR) fluid actuator unit between bodies mau have at least one MR fluid actuator unit including a motor assembly, the motor assembly operating within a first frequency range, and a MR fluid clutch apparatus connected to the motor assembly to apply a variable amount of force from the motor assembly between at least two of the bodies, the MR fluid clutch apparatus operating within a second frequency range, the second frequency range being higher than the first frequency range. At least one sensor provides data indicative of a state of at least one of the bodies. The system may be used for: receiving the data from the at least one sensor: determining from the data that the motor assembly has to accelerate or decelerate to control an amplitude and direction of a relative speed between input and output of the MR fluid clutch apparatus to transmit a desired force between the bodies: controlling the motor assembly to accelerate or decelerate toward the given value at the first frequency range, and concurrently reducing a torque transmission from the MR fluid clutch apparatus during a lag period in which the torque transmission acts opposite to the desired force.

### CROSS-REFERENCE TO RELATED APPLICATION

The present application claims the priority of U.S. Patent Application No. 63/341,501, filed on May 13, 2022, the contents of which are incorporated herein by reference.

### TECHNICAL FIELD

The present application relates generally to magnetorheological (MR) fluid clutch apparatuses, and more particularly, to bodies using such apparatuses for dynamic control of motion in active motion control, suspension systems, collaborative robots or haptic systems.

### BACKGROUND OF THE ART

A body, such as a vehicle, moving in a desired direction, most inevitably experiences motion in other directions as well. This undesired motion often arises from disturbances in the medium through which the body travels. For example, in a vehicle, whether one travels by land, sea, or air, one might encounter imperfections, bumps, waves, air pockets, and the like. Such random acceleration causes displacement, discomfort or annoyance to those in the vehicle. This can also cause vibrations and undesired horizontal or vertical movement to goods in the body. For certain susceptible individuals, these random accelerations can trigger a bout of motion sickness. In some cases, a particularly violent acceleration may cause the operator to briefly lose control of the body. Also, goods can be damaged when submitted to acceleration or shocks. Even when stationary, there may be some residual vibration associated with the vehicle's engine. In motion, even on smooth roads, this residual vibration can become tiresome.

A primary purpose of a body's suspension system is to provide vertical or horizontal compliance between the medium, such as the road, and the chassis, in order to isolate the chassis occupants or goods from the roughness in the road and to maintain the contact point(s) with the road, thus providing a path for transferring forces from the contact point(s) to the chassis. In applications where the body is a wheeled body, the contact point is also used to change the speed or direction of the body. In a wheeled body, examples of some common independent suspension linkages are known generally as strut & link (also called MacPherson strut), double A-arm (also called double wishbone or SLA), trailing arm, semi-trailing arm, multi-link, fork, scissor, pivot to name but a few.

In vehicles such as automobiles, each wheel assembly is connected to the chassis by one or more links. A link is defined as a substantially rigid member with a joint or joints at each end that allows a particular motion to take place. It is these links that control the motion (or path) of the wheel as it moves up and down over road bumps.

The design of the suspension system for damping oscillations of the wheel usually represents a compromise between isolating the vehicle body from high-frequency oscillations (secondary ride) that may be produced by road surface irregularities and, on the other hand, achieving a high level of driving comfort for low-frequency oscillations of the vehicle body (primary ride).

Generally, all kinematically-induced wheel forces are either forces created by the interaction between the tires and the road, or inertial forces generated by the motion of the unsprung mass. The forces occurring between the tires and the road are transferred via the suspension system to the body. As long as the wheel assembly does not change its horizontal position or angular orientation relative to a smooth road surface, no substantial lateral or longitudinal tire forces (ignoring friction) will be created.

In an active suspension, controlled forces are introduced in the suspension, such as by hydraulic or electric actuators, between the sprung mass of the vehicle body and its occupants, and the unsprung mass of the wheel assemblies. The unsprung mass is the equivalent mass that reproduces the inertial forces produced by the motions of those parts of the vehicle not carried by the suspension system. This primarily includes the wheel assemblies, any mass dampers associated with the wheel assemblies, and some portion of the mass of the suspension links. The sprung mass is the mass of those parts of the vehicle carried by the suspension system, including the body. Active suspension systems may introduce forces that are independent of relative wheel motions and velocities.

A known active suspension system uses a linear motor direct drive approach. This approach may be viewed as being adequate from a performance standpoint. However, this approach may be said to be weak, relatively heavy and costly. Another known suspension system is the electro-hydraulic active system based on a pump adjusting the pressure of the hydraulic fluid in a conventional hydraulic damper. The electro-hydraulics approach is usually not highly dynamic enough (not enough bandwidth) to cope with the full spectrum of road induced perturbations. This approach is usually able to cope with the primary ride attitude vehicle change (e.g. pitch and roll) but may deteriorate the secondary ride because it adds some inertance or reflected inertia on the unsprung mass side. In other word, the improvement to the primary ride is achieved but instead of reducing the vibration associated with the frequencies of the secondary ride, some active suspension system worsen them, making them less appealing. In order to resolve this problem, a spring has been introduced in series with some suspension actuators and the unsprung mass in order to achieve a series-elastic suspension system. However, this added spring may usually come with a decrease in the natural frequency of the system, hence less mechanical bandwidth and reduced controllability.

Actuators using magnetorheological (MR) fluid clutch apparatuses have been proposed to solve most of the previous problem, as active suspension systems with such MR fluid actuators may exhibit high bandwidth and high transparency. However, active suspension systems may be viewed as more complex and cost-intensive, such as in configurations with two MR fluid clutch apparatuses per unsprung mass.

For that reason, there is still a need for a more economical active suspension system.

And while the above description refers to vehicles, similar situations may be found in other type of devices, apparatuses, systems, like haptic feedback devices used to transmit force feedback to humans or robots interacting with human or difficult to predict environments.

### SUMMARY

It is an aim of the present disclosure to provide novel active motion control systems using magnetorheological fluid clutch apparatuses.

It is a further an aim of the present disclosure to provide a method and system for minimizing controllability losses during reversals when the dynamics resulting from a combination of motor and reduction mechanism of a MR fluid actuator are slower than motion system requirements.

It is a further aim of the present disclosure to provide novel active suspension control systems using magnetorheological fluid clutch apparatuses.

It is a still further aim of the present disclosure to use such systems in vehicles.

In accordance with a first aspect of the present disclosure, there is provided a system for operating a magnetorherological (MR) fluid actuator unit between bodies, comprising: at least one MR fluid actuator unit including a motor assembly, the motor assembly operating within a first frequency range, and a MR fluid clutch apparatus connected to the motor assembly to apply a variable amount of force from the motor assembly between at least two of the bodies, the MR fluid clutch apparatus operating within a second frequency range, the second frequency range being higher than the first frequency range; at least one sensor for providing data indicative of a state of at least one of the bodies; a processing unit; and a non-transitory computer-readable memory communicatively coupled to the processing unit and comprising computer-readable program instructions executable by the processing unit for: receiving the data from the at least one sensor; determining from the data that the motor assembly has to accelerate or decelerate to control an amplitude and direction of a relative speed between input and output of the MR fluid clutch apparatus to transmit a desired force between the bodies; controlling the motor assembly to accelerate or decelerate toward the given value at the first frequency range, and concurrently reducing a torque transmission from the MR fluid clutch apparatus during a lag period in which the torque transmission acts opposite to the desired force.

Further in accordance with the first aspect, for instance, the motor assembly includes a motor and a reduction mechanism.

Still further in accordance with the first aspect, for instance, reducing the torque transmission includes turning the MR fluid clutch apparatus off.

Still further in accordance with the first aspect, for instance, reducing the torque transmission includes delaying a response of the MR fluid clutch apparatus during the lag period.

Still further in accordance with the first aspect, for instance, reducing the torque transmission includes delaying a response of the MR fluid clutch apparatus during the lag period when the system is held inside a pre-defined operating zone.

Still further in accordance with the first aspect, for instance, the motor assembly includes at least an unidirectional motor.

Still further in accordance with the first aspect, for instance, the motor assembly includes at least a bi-directional motor.

Still further in accordance with the first aspect, for instance, determining from the data that the motor assembly has to accelerate or decelerate to control an amplitude includes controlling the direction of a relative speed between the input and the output of the MR fluid clutch apparatus to transmit the desired force between the bodies.

Still further in accordance with the first aspect, for instance, two of the MR fluid actuator unit may be present, each said MR actuator unit having a bi-directional motor connected to a respective one of the MR fluid clutch apparatus, the two MR fluid actuator units controlling the desired force on a common output.

Still further in accordance with the first aspect, for instance, a first of the bodies is a mass and a second of the bodies is a structure.

Still further in accordance with the first aspect, for instance, the structure is sprung from the mass.

Still further in accordance with the first aspect, for instance, the system is an active suspension generating energy in passive quadrants.

Still further in accordance with the first aspect, for instance, the system is an active suspension using energy in the active quadrants.

Still further in accordance with the first aspect, for instance, the bodies are links of a robot.

Still further in accordance with the first aspect, for instance, the robot is a collaborative robot.

Still further in accordance with the first aspect, for instance, the bodies are a fixed chassis and a haptic device.

Still further in accordance with the first aspect, for instance, the lag period corresponds to a time duration during an absolute slip speed of the MR fluid clutch apparatus is smaller than a required slip threshold.

Still further in accordance with the first aspect, for instance, the system may be used for determining from the data a required speed amplitude to be generated by the bi-directional motor; maintaining slippage in the MR fluid clutch apparatus to remain in a current direction and be unresponsive to the required slip speed amplitude reversal if the required absolute torque amplitude is within a torque amplitude threshold, and, reversing a slip speed of the MR fluid clutch apparatus if the required absolute torque amplitude is beyond the torque amplitude threshold in the opposite direction.

In accordance with a second aspect of the present disclosure, there is provided a system for operating a suspension between a mass and a structure, comprising: a bi-directional motor; a magnetorherological (MR) fluid clutch apparatus coupling the bi-directional motor to the mass to apply force from the bi-directional motor to the mass; at least one sensor for providing data indicative of a state of the mass and/or of the structure; a processing unit; and a non-transitory computer-readable memory communicatively coupled to the processing unit and comprising computer-readable program instructions executable by the processing unit for: receiving the data from the at least one sensor; determining from the data a required speed amplitude to be generated by the bi-directional motor; maintaining slippage in the MR fluid clutch apparatus to remain in a current direction and be unresponsive to the required slip speed amplitude reversal if the required absolute torque amplitude is within a torque amplitude threshold, and, reversing a slip speed of the MR fluid clutch apparatus if the required absolute torque amplitude is beyond the torque amplitude threshold in the opposite direction.

In accordance with a third aspect of the present disclosure, there is provided a system for operating a suspension between a mass and a structure, comprising: a bi-directional motor, the bi-directional motor operating within a first frequency range; a magnetorherological (MR) fluid clutch apparatus coupling the bi-directional motor to the mass to apply force from the bi-directional motor to the mass, the MR fluid clutch apparatus operating within a second frequency range, the second frequency range being higher than the first frequency range; at least one sensor for providing data indicative of a state of the mass and/or of the structure; a processing unit; and a non-transitory computer-readable memory communicatively coupled to the processing unit and comprising computer-readable program instructions executable by the processing unit for: receiving the data from the at least one sensor; determining from the data that the bi-directional motor switches direction; concurrently controlling the bi-directional motor to reducing a torque transmission from the MR fluid clutch apparatus when the slip is not in the desired direction.

### DESCRIPTION OF THE DRAWINGS

FIG. 1 is a schematic view of a generic magnetorheological (MR) fluid clutch apparatus, incorporating features of the present disclosure.

FIG. 2 is a sectioned schematic view of the MR fluid clutch apparatus of FIG. 1, in accordance with an embodiment.

FIG. 3 is a schematic representation of a MR fluid actuator using a single motor and a single clutch.

FIG. 4 is a schematic representation of a MR fluid actuator using a single motor and double clutch.

FIG. 5 is a schematic representation of two MR fluid actuators organized in a parallel path.

FIG. 6 is the schematic representation of a MR fluid actuator used to control a vehicle seat.

FIG. 7 is a schematic representation of a MR fluid actuator used to control a truck cabin.

FIG. 8 is a schematic representation of a MR fluid actuator used to control the frame of a vehicle.

FIG. 9 is a graph showing force and speed of a typical vehicle active suspension.

FIG. 10 is the typical bode plot of a MR fluid actuator.

FIG. 11 is a typical PSD graph of an active suspension using MR fluid actuation compared to a passive suspension.

FIG. 12 is a schematic representation of an exemplary comfort improvement of an active suspension using a MR fluid actuator compared to state of the art technologies.

FIG. 13 is a graph of the ISO2631 filter used to qualify the Mechanical Vibration And Shock-Evaluation Of Human Exposure To Whole-Body Vibration.

FIG. 14 is a schematic representation of a vehicle suspension using a linear MR fluid actuator.

FIG. 15 is a perspective view of an exemplary embodiment of a linear MR fluid actuator.

FIG. 16a is a more detailed representation of the linear MR fluid actuator of FIG. 15

FIG. 16b is an alternative configuration of the linear MR fluid actuator of FIG. 15 with a single motor.

FIG. 17 is a schematic representation of a vehicle suspension using a rotary MR fluid actuator.

FIG. 18a is a schematic representation of a possible rotary MR fluid actuator.

FIG. 18b is an alternative configuration of the linear actuator of FIG. 18 with a single motor.

FIG. 19 is a more detailed representation of the rotary MR fluid actuator of FIG. 15

FIG. 20 is a schematic representation of an exemplary linear MR fluid actuator using a rack and pinion couple with a single motor and a single clutch.

FIG. 21 is a pair of graphs showing the condition of a reversal in a MR motion control system.

FIG. 22 is a series of graphs showing a single motor single clutch active suspension limitations in comparison to a double clutch active suspension design.

FIG. 23 is a pair of graphs of exemplary motor consumption for a single motor single clutch active seat suspension versus a single motor double clutch suspension.

FIG. 24 is table of exemplary results of a single motor single clutch active seat suspension versus a single motor double clutch suspension over different types of road.

FIG. 25 is a pair of graphs showing a keep-slip function of the single motor single clutch system of FIG. 20.

FIG. 26 is a series of graphs showing a let-go function of the single motor single clutch system of FIG. 20.

FIG. 27a is a graph showing linear and non-linear plot lines for torque multiplier as a function of slip target.

FIG. 27b is a graph showing linear and non-linear plot lines for torque multiplier as a function of slip target, with a zero command.

FIG. 28 is a block diagram of a controller for any of the MR fluid actuators described herein.

### DETAILED DESCRIPTION

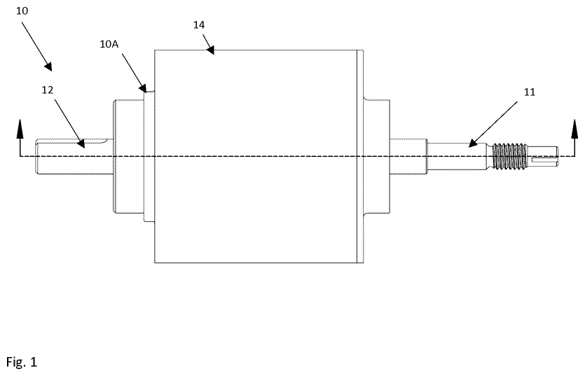

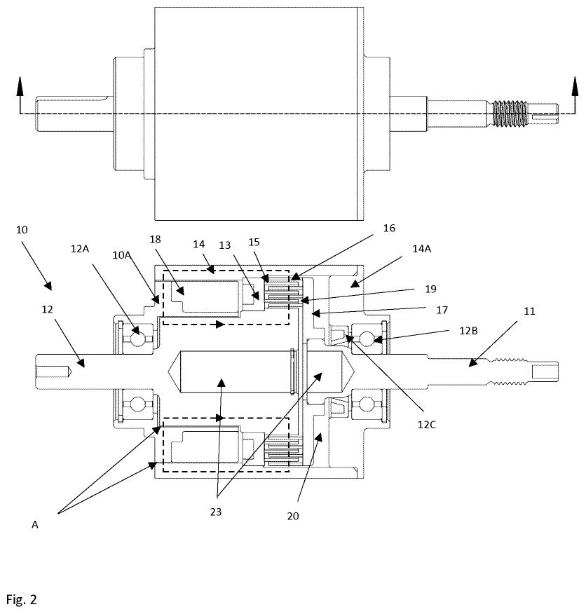

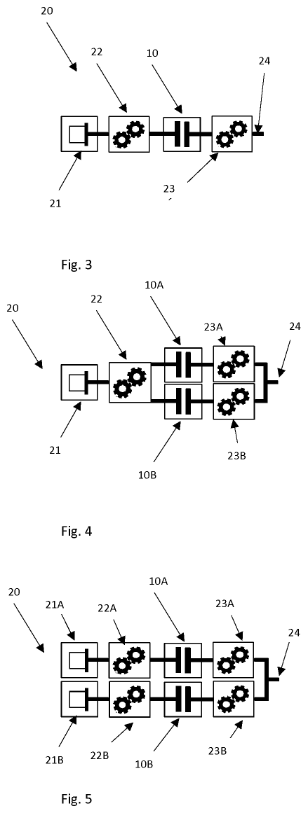

Referring to the drawings and more particularly to FIG. 1, there is illustrated a magnetorheological (MR) fluid clutch apparatus 10 configured to provide a mechanical output force based on a received input current. The MR fluid clutch apparatus 10 is shown as being of the type having collinear input and output shafts. However, the concepts described herein may apply to other configuration of MR fluid clutch apparatuses, for instance some with an input or output outer shell/casing for an output or input shaft, etc. The principles illustrated here will be performed using a MR fluid clutch apparatuses of drum type but could also be applied to a disc type MR fluid clutch apparatus. In the following description, starting with FIG. 3, reference is made to systems and MR fluid actuators having one or more MR fluid clutch apparatuses 10. When such reference is made, the MR fluid clutch apparatus 10 may be as described in FIGS. 1 and 2, or may be any other MR fluid clutch apparatus 10 such as versions with discs, unless stated otherwise. In some embodiments, MR fluid clutch apparatus 10 may be normally open, normally closed, or partially closed clutch type unit.

The MR fluid clutch apparatus 10 may transmit an output force in response to an input current received from an operator, to transmit an input force and an output force based on the magnetization level of a magnetizable part in the magnetic circuit when there is no input current. The example MR fluid clutch apparatus 10 may have a stator 10A to which the MR fluid clutch apparatus 10 is connected to a structure. The MR fluid clutch apparatus 10 features driven member 11 and driving member 12 separated by gaps filled with an MR fluid, as explained hereinafter. The driving member 12 may receive rotational energy (torque) from a power device, such as a motor, with or without a transmission, such as a reduction gear box, etc.

According to an embodiment, the driving member 12 may be in mechanical communication with a power input, and driven member 11 may be in mechanical communication with a power output (i.e., force output, torque output). The stator 10A, the driven member 11 and the driving member 12 may be interconnected by bearings 12A and 12B. In the illustrated embodiment, the bearing 12A is between the stator 10A and the driving member 12, whereas the bearing 12B is between the driven member 11 and the driving member 12. Seals 12C may also be provided at the interface between the driven member 11 and the driving member 12, to preserve MR fluid between the members 11 and 12. Moreover, the seals are provided to prevent MR fluid from reaching the bearing 12B or to leak out of the apparatus 10.

As shown with reference to FIG. 2, drums are located circumferentially about the rotational axis CL. Some support must therefore extend generally radially to support the drums in their circumferential arrangement. In accordance with one embodiment, referring to FIG. 2, a low permeability input drum support 13 (a.k.a., radial wall) projects radially from a shaft of the driving member 12. The input drum support 13 may be connected to an input rotor 14 defining the outer casing or shell of the MR fluid clutch apparatus 10. The input rotor 14 may therefore be rotatably connected to the driven member 11 by the bearing 12B. In an embodiment, the input rotor 14 has an input rotor support 14A which forms a housing for the bearing 12B. According to an embodiment, the input rotor support 14A is an integral part of the input rotor 14, and may be fabricated as a single piece. However, this is not desirable as the input rotor support 14A is ideally made from a low permeability material and the input rotor is made from a high permeability material. As another embodiment, as shown in FIG. 2, the input rotor support 14A may be defined by an annular wall fabricated separately from a remainder of the input rotor 14, though both are interconnected for concurrent rotation. Therefore, the shaft of the driving member 12, the input drum support 13 and the input rotor 14 rotate concurrently. In an embodiment, it is contemplated to have the outer shell of the MR fluid clutch apparatus 10 be part of the stator 10A, or of the driven member 11.

The input drum support 13 may support a plurality of concentric annular drums 15, also known as input annular drums. The input annular drums 15 are secured to the input drum support 13. In an embodiment, concentric circular channels are defined (e.g., machined, cast, molded, etc) in the input drum support 13 for insertion therein of the drums 15. A tight fit (e.g., force fit), an adhesive and/or radial pins may be used to secure the drums 15 to the input drum support 13. In an embodiment, the input drum support 13 is monolithically connected to the shaft of the driving member 12, whereby the various components of the driving member 12 rotate concurrently when receiving the drive from the power source.

The driven member 11 is represented by an output shaft, configured to rotate about axis CL as well. The output shaft may be coupled to various mechanical components that receive the transmitted power output when the clutch apparatus 10 is actuated to transmit at least some of the rotational power input. In some embodiments, some other components of MR fluid clutch apparatus 10 may be attached or combined to other components (i.e., the driving member 12 may be combined with the stator 10a, the drum support 13, the input rotor 14 and the rotor support 14A so all those part may be anchored to a chassis while not rotating).

The driven member 11 also has a one or more concentric annular drums 16, also known as output drums, mounted to an output drum support 17. The output drum support 17 may be an integral part of the output shaft, or may be mounted thereon for concurrent rotation. The annular drums 16 are spaced apart in such a way that the sets of output annular drums 16 fit within the annular spaces between the input annular drums 15, in intertwined fashion. When either of both the driven member 11 and the driving member 12 rotate, there is no direct contact between the annular drums 15 and 16, due to the concentricity of the annular drums 15 and 16, about axis CL.

The annular spaces between the input annular drums 15 of the driving member 12, and the output annular drums 16 of the driven member 11 are filled with the MR fluid 19. The MR fluid 19 used to transmit force between the driven member 11 and the driving member 12 is a type of smart fluid that is composed of magnetisable particles disposed in a carrier fluid, usually a type of oil, but the carrier fluid may also be present in a gaseous form (a.k.a., dry MR fluid). When subjected to a magnetic field, the fluid may increase its apparent viscosity, potentially to the point of becoming a viscoplastic solid. The apparent viscosity is defined by the ratio between the operating shear stress and the operating shear rate of the MR fluid between opposite shear surfaces. The magnetic field intensity mainly affects the yield shear stress of the MR fluid.

According to FIG. 3, a MR fluid actuator 20 (also known as a MR fluid actuator unit) is shown having a MR fluid clutch apparatus 10 of the type described above. The actuator is composed of a motor 21, an input gearbox 22, a MR fluid clutch apparatus 10, an output gearbox 23 and an output 24, though one or both of the gearboxes may be optional.

Another type of MR fluid actuator is shown on FIG. 4 and is composed of a single motor, an input gearbox 22, two MR fluid clutch apparatuses 10A and 10B, turning in opposite direction an applying antagonistic forces on the output 24, each through gearbox 23A and 23B.

Another type of MR fluid actuator is shown on FIG. 5 and is composed of two MR fluid actuators similar to the one of FIG. 3 working in parallel in order to apply a force on a single output 24, with the gearboxes being optional. The first branch of actuation is composed of a motor 21A, an input gearbox 22A, a MR fluid clutch apparatus 10A, an output gearbox 23A driving the output 24. The first second branch of actuation is composed of a motor 21B, an input gearbox 22B, a MR fluid clutch apparatus 10B, an output gearbox 23B driving the same output 24.

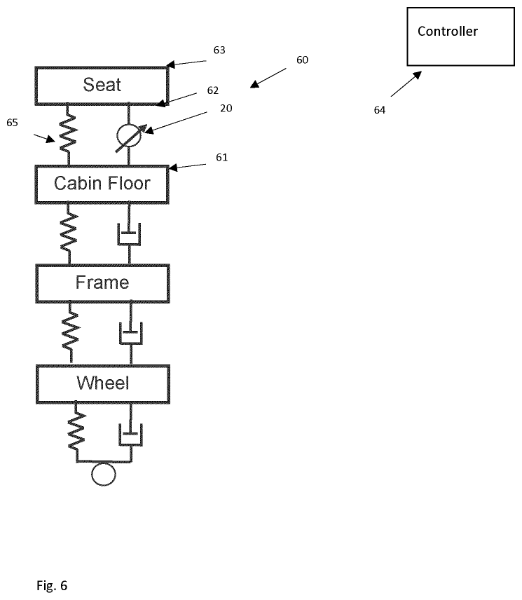

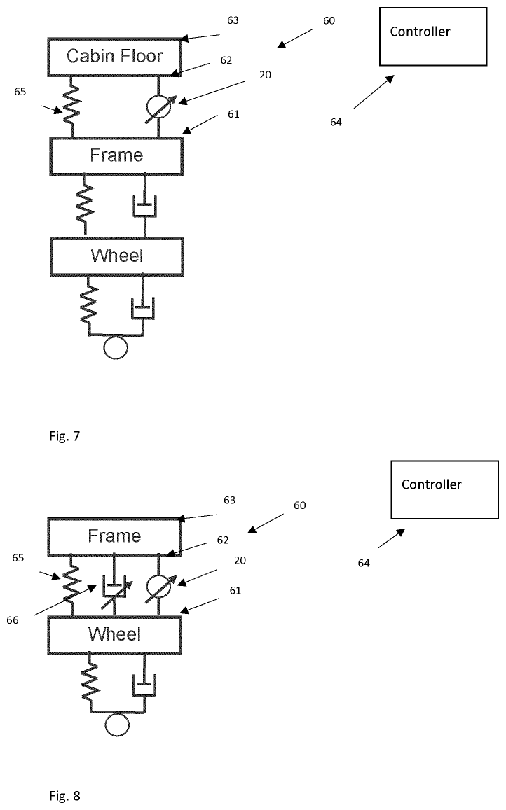

FIGS. 6, 7 and 8 show a MR fluid actuator of any type taken from FIG. 3, 4 or 5 integrated in an active suspension system 60. The suspension 60 is said to be “active”, in that it applies forces to different types of masses, such as a platform, by a controlled MR fluid actuator 20 relative to a structure of the vehicle. More specifically, FIG. 6 is showing an active suspension 60 controlling the seat of a vehicle, FIG. 7 is showing an active suspension 60 controlling the cabin of a truck and FIG. 8 is showing an active suspension 60 installed to control the frame of a vehicle. Each active suspension 60 may control the forces between a suspended platform or like mass and an underlying base or like structure. The forces may be independent of relative motions and velocities in the environment of or at a suspended platform. The active suspension system 60 has or receives actuation from at least a power source 21 such as a motor. Motor 21 may be electric, pneumatic, hydraulics, ICE or any other type. The active suspension system 60 has a mechanism, in the form of linkage system, coupled to platform 61 (e.g., seat, pallet, stretcher, truck cabin, transportation box, only to name a few) for transmitting motion output by the MR fluid clutch apparatus(es) 10 to the platform 61. A sensor or sensors 62 provide information indicative of a state of the suspended platform 63, and a controller 64 receives the information indicative of the state of the platform 63 and outputs a signal to the MR fluid clutch apparatus(es) 10 to cause the MR fluid clutch apparatus(es) 10 to exert a force on the suspended platform 63. Alternatively, the sensor(s) 62 may be on the structure supporting the platform 63, and/or on components of the active suspension system 60, to measure the state of any such component. Additional components may be provided, such as an air spring 65 or like biasing device or suspension component, in parallel to the linkages. Other actuator or damping device 66 may also be added in parallel or in series with the MR fluid actuators 20. Damping devices may be of adjustable type or non-adjustable type. It is to be noted that for a reason of simplicity, the explanation is described with the control of one degree of freedom but that multiple actuators could be used to control multiple degrees of freedom of the body. Moreover, the multiple MR fluid clutch apparatuses could share the same power source, as is the case in FIG. 3 with both MR fluid clutch apparatuses 10 receiving the actuation power from the single motor 21, via a transmission 22. The transmission 22 is illustrated as featuring a gearbox but pulleys and belts may be used. Transmission 22 but may also be of other type such as a, chain and pinions, etc., only to name a few. Other devices can be used as variable force sources as alternatives to the air spring 65.

The combination of a variable power source with the MR fluid clutch apparatus(es) 10 presents advantages of a hybrid system where one device or the other (or both simultaneously) can be controlled depending on the condition of operation. In an example where the power source is an electric motor, the electric motor speed and available torque can be controlled as well as the torque transmitted by the MR fluid clutch apparatus(es) 10. This may increase the potential points of operation while increasing the overall performance or efficiency of the system. The output of the MR fluid clutch apparatuses can be decoupled from the input. In some application, this can be useful to decouple the inertia from the input in order not to affect the time of response of the output.

FIGS. 6 to 8 are representative of an implementation of the system. Sensors 62 gather information indicative of a state of the platform 63, of the structure supporting the platform 62 and/or components of the active suspension system 60, and controller 64 outputs a signal to the MR fluid actuator 20 based on the state. For example, the controller 64 may be programmed with a desired behavior for the platform 63. The desired behavior may be a comfort behavior, in which the platform 63 must not be exposed to accelerations beyond a given level, in a particular direction (e.g., up and down). Therefore, the controller 64 will control the action of the MR fluid actuator 20 to ensure that the platform 63 moves within the limits of the desired behavior, in spite of disturbances sustained by the structure (e.g., vehicle chassis). Likewise, the desired behavior could be a control behavior entailing that the platform 63 limits its span of movements in some controllable directions. Therefore, the active suspension system 60, and other embodiments of suspension described below, adopt an active control in that force is applied to control the movement behavior of an item, such as a passenger supporting platform or a wheel assembly, to name but a few examples.

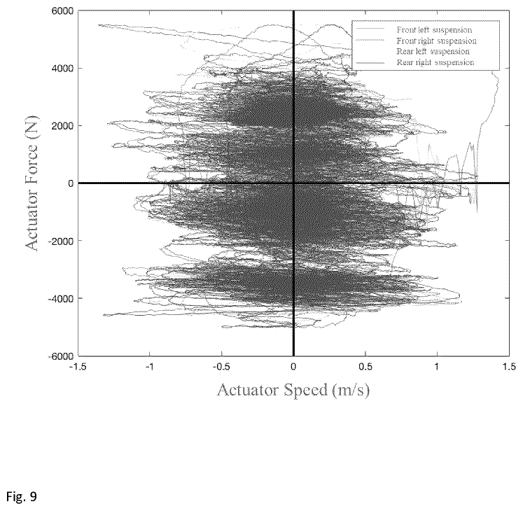

FIG. 9 shows an exemplary the force versus velocity (F-V) graph of a typical active suspension of vehicle. The F-V of each of the four wheels is illustrated.

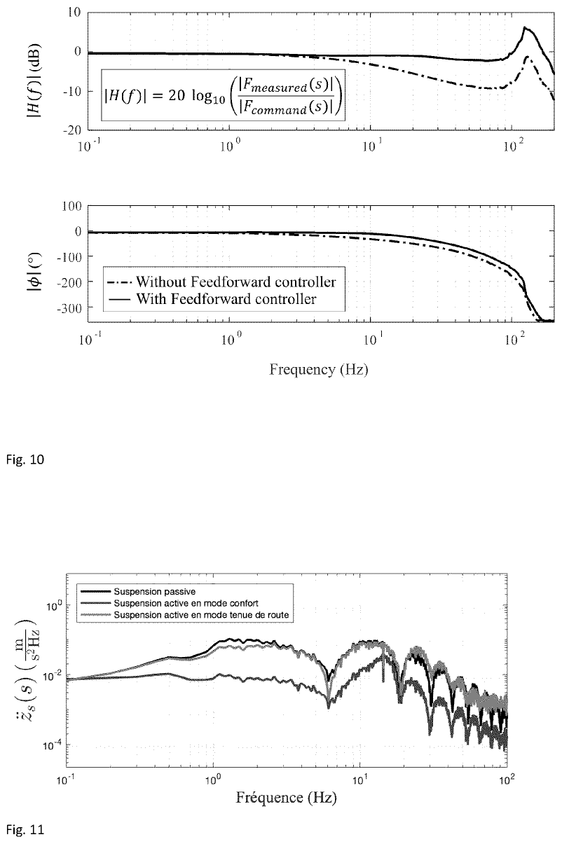

FIG. 10 shows an exemplary mechanical transfer function of a MR fluid actuator 20 when the MR fluid clutch apparatus 10 is maintained in slippage. Such transfer function is illustrated when used with and without feedforward controller. MR fluid actuators such as 20 are known to provide high mechanical bandwidth (e.g. >10 Hz) when one or more MR fluid clutch apparatuses are maintained in slippage.

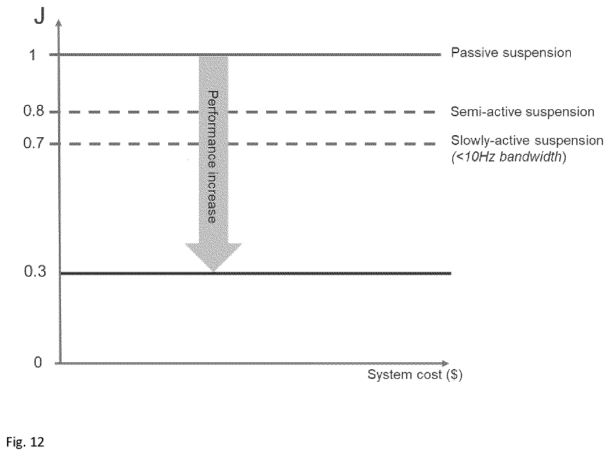

FIG. 11 is an exemplary power spectral density (PSD) graph showing the typical frequencies that a vehicle suspension system is submitted to. Significant power may be present up to roughly 50 Hz so it may be an advantage for an active suspension system to provide a counter force up to that frequency.

FIG. 12 shows the discomfort index J of various passive, semi-active, slow active and full active suspension. The lower the discomfort index J is the more comfortable the suspended platform may be.

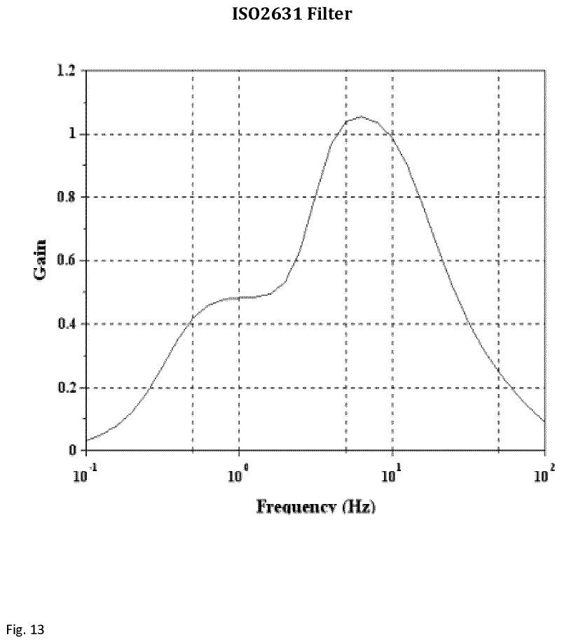

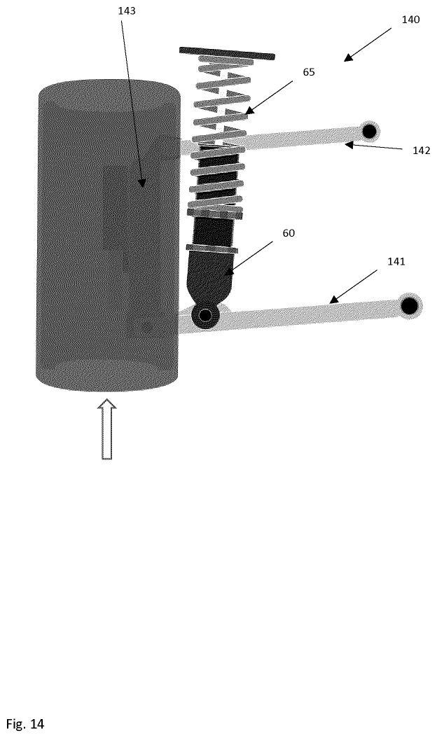

FIG. 13 shows the ISO 2631 filter used to qualify the Mechanical Vibration And Shock-Evaluation Of Human Exposure To Whole-Body Vibration. It may be seen that the most important frequencies to improve human comfort are between 1 Hz and 30 Hz, frequencies for which the gains are larger than 0.5 on the filter.

FIG. 14 shows a linear MR fluid actuator that may be used in various wheel suspensions for suspending a wheel assembly from a sprung body of a wheeled vehicle. The MR fluid actuator 20 allows the wheel assembly to move relative to the sprung body through a bounce and rebound vertical travel, as limited by mechanical stops. The wheel assembly may be the rear wheel assembly and/or the front wheel assembly of a passenger vehicle such as an automobile, a front or rear wheel assembly of a motorcycle, the front or rear wheel assembly of a transportation cart, only to name a few. In some configurations, the relative rotational centers are disposed rearward and outboard of their respective pivots.

In some cases, the upper relative rotation center and upper pivot are disposed along a first generally horizontal line, and the lower relative rotation center and lower pivot are disposed along a second generally horizontal line, with the automobile at rest and loaded to its design weight. The upper and lower rotation centers are preferably separated from their respective pivots by different arm lengths. The term “design weight” should be understood from ISO/IS 2958, which specifies the loading for passenger vehicles as a function of the number of seats. Typically, the suspension is roughly at the center of its vertical travel at rest at the design weight. In some embodiments, the active suspension system includes an electric motor adapted to receive electrical power, coupled with one of more of the MR fluid actuator of the active suspension system 60 to produce the active control force.

The active suspension system may include subsystems 140 for each wheel assembly. In some configurations, a first structural link 141 may be coupled to the wheel assembly to define a first relative rotation center, and may be rotationally coupled to the sprung body at a first pivot, with the suspension further including a second structural link 142 coupled to the wheel assembly to define a second relative rotation center above the first relative rotation center, and rotationally coupled to the sprung body at a second pivot above the first pivot. The wheel suspension may define a geometry selected to minimize the horizontal kinetic displacement of the wheel assembly as the structural link 143 attached between any of the first or second structural and the sprung body moves through an active control range over its vertical travel.

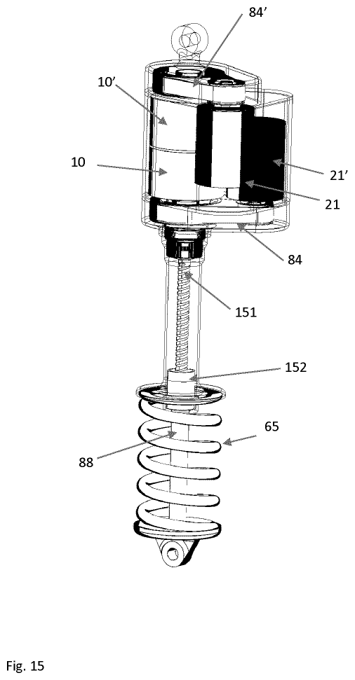

Referring to FIG. 15, the subsystem uses a pair of MR fluid clutch apparatuses 10, 10′ to control the rotation of a threaded rod 151 of a ballscrew or like actuator featuring a threaded nut 152, using the power provided by the motors 21,21′ (although a single motor could be used as well as exemplified previously). The rotational outputs from motors 21,21′ are hence converted into back and forth translation of the threaded rod 151. The subsystem of FIG. 15 may be placed in the middle of a coil spring (as in FIG. 15) or in parallel to a strut or spring/damper system.

The rotational output from the motors 21 and 21′ is transmitted to the input of MR fluid clutch apparatuses 10 and 10′ using mechanisms 84 and 84′. The input reduction mechanism 84 may turn in the clockwise direction, while the input reduction mechanism 84′ may turn in the counter clockwise direction. A belt system may present the advantage that it has less backlash than some other types of reduction mechanism. Other type of backlash reduction strategies may also be desirable, like preloaded gear or preloaded ball screw, only to name a few. Hence, the rotations caused by either one of the MR fluid clutch apparatuses 10 or 10′ are converted by the engagement of the ballscrew rod 151 and nut 152 into back and forth translations of the nut 152 connected to the sliding member 88. The subsystem may be placed in the middle of the hollow central volume of a coil spring 65 or in parallel to a strut or spring/damper system.

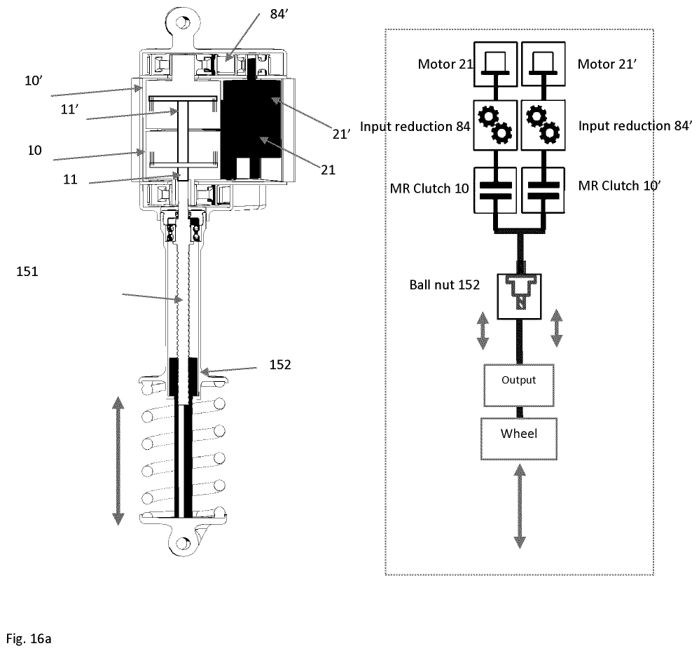

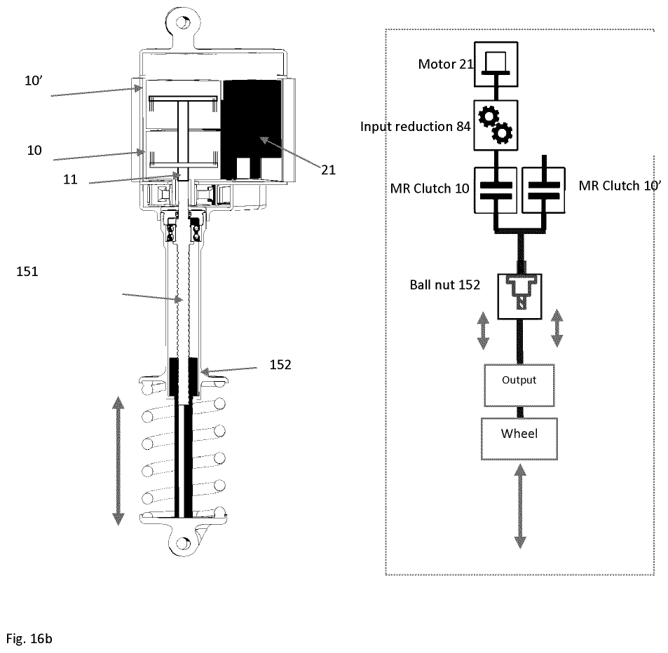

FIG. 16a shows a cross section of the device of FIG. 15, illustrating that the output members of both MR fluid clutch apparatuses 10 and 10′ may be connected to a single output, being in this case the threaded ballscrew rod 151 of a ball-screw mechanism, or other rod for other types of linear actuators. In the shown embodiment, the outputs are connected to the screw but other embodiments may be possible where the output of the MR fluid clutch apparatuses 10 and 10′ may be connected to a common ball nut, or each to separate ball nuts. Connecting each clutch to an individual ball nut may present the advantage of reducing the backlash of the system when both clutches are working antagonistically.

FIG. 16b shows a cross section of a device similar to the device of FIG. 16a with an alternative configuration where only one MR fluid clutch apparatus 10 is connected to the motor 21. The MR fluid clutch apparatus 10′ is connected to the chassis of the device. The output members of both MR fluid clutch apparatuses 10 and 10′ are connected to a single output, being the threaded ballscrew rod 151 of a ball-screw mechanism.

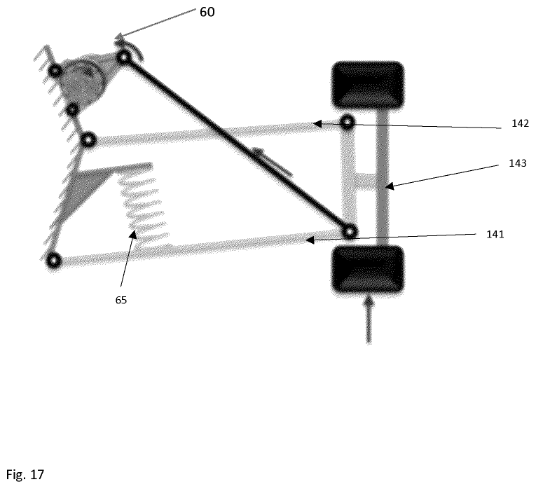

In the embodiments shown in FIG. 17, the motor and MR fluid clutch apparatuses 10 may be located distally from the wheel assemblies, in which various configurations are shown to transmit motor actuation to wheel assemblies. FIG. 17 shows a rotary mechanisms that is configured to receive force from the MR fluid clutch apparatuses 10 as part of the active suspension system 60, to actively control the wheel assemblies or other parts of a vehicle. Distal actuation may be transmitted using a push rod, but could also use hydraulic tubes or cables, forming part of the mechanism.

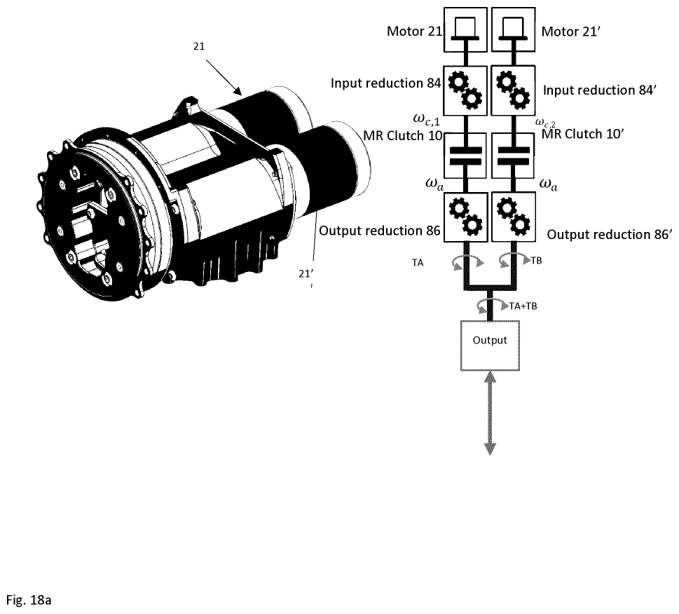

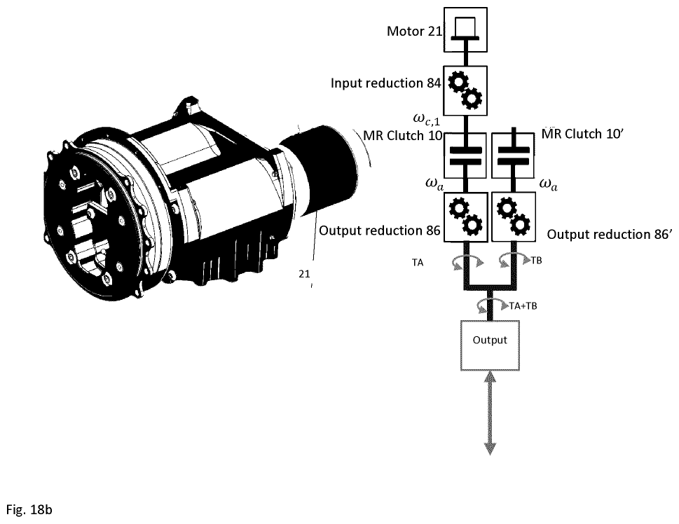

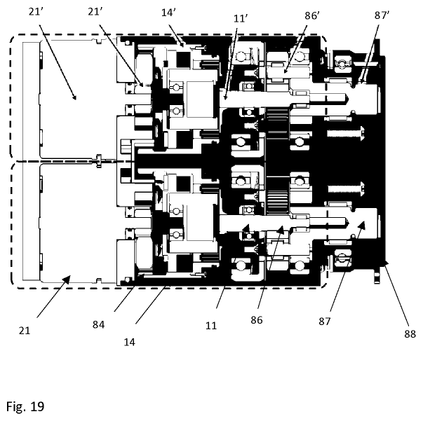

Referring to FIGS. 18a and 19, a similar configuration to that of FIG. 15 is illustrated, but using an output reduction transmission 86 (e.g., bevel gears) and 86′ instead of ball screw, the output reduction mechanisms 86 and 86′ each having an output shaft 87 and 87′ that is connected to a single actuator output member 88.

The embodiment of FIG. 18a, or of other embodiments described herein, may also be used as part of a robot joint. Such systems are described in International patent application publication no. WO2021155478A1, incorporated herein by reference.

FIG. 18b shows a cross section of a device similar to the device of FIG. 18a with an alternative configuration where only one MR fluid clutch apparatus 10 is connected to a motor 21. The MR fluid clutch apparatus 10′ is connected to the chassis of the device. The output members of both MR fluid MR fluid clutch apparatuses 10 and 10′ are connected to a single output.

In accordance with another embodiment (not shown), the active suspension system may be applied to a roll bar for a motor vehicle. Roll bars may be on the rear wheels of the vehicle, but another roll bar could be used on the front wheels as well. Roll bar may be a split torsion bar, which is fastened rotatably to a vehicle chassis. It is also considered for the clutch arrangement to connect the first roll bar portion to the second roll bar portion in such a way that they rotate in unison as a function of the actual and/or expectable lateral acceleration of the vehicle. It is thus possible to automatically uncouple the roll bar during the straight-line travel of the vehicle and to automatically couple it again during travel in a curve.

A clutch arrangement of a roll bar can be embodied according to an alternative embodiment if the first roll bar portion and the second roll bar portion are connectable to one another, to rotate in unison, such that it is axially displaceable as a whole by the clutch arrangement. The clutch arrangement can be preferably controlled as a function of the velocity of the vehicle and the steering angle and/or the angular velocity of the steering wheel and/or the lateral acceleration of the vehicle, all of which may be part of the state of the vehicle obtained by the sensors 62. To rule out a safety hazard during a possible malfunction, the clutch arrangement may have redundancy such that remains at least partially functional in case of a defect. In another embodiment, the active suspension system with the MR fluid clutch apparatuses 10 can be installed in parallel or concentrically to a soft torsion bar and only used as a stiffness increaser. Accordingly, the active suspension system as described above is a relative cost-effective semi-active or fully active roll bar which is always sufficiently effective during travel in a curve as well as in evading maneuvers and also affects the spring action characteristics of the vehicle in order to enhance driving smoothness.

In another embodiment (not shown), the MR fluid actuators such as 20 are located distally while a spring 65 and a hydraulic actuator or piston are located at each wheel, in a parallel arrangement. The MR fluid clutch apparatuses 10 provide active motion control to each wheel in two directions using two distinct hydraulic conduits. One of the hydraulic conduits may be used to transmit the required active motion control forces to hydraulic actuator or piston at the wheel in one direction while the other conduit may be used to transmit the force in the other direction. The biasing member or spring 65 may be used to support the sprung weight and transmit part of the load to the unsprung weight.

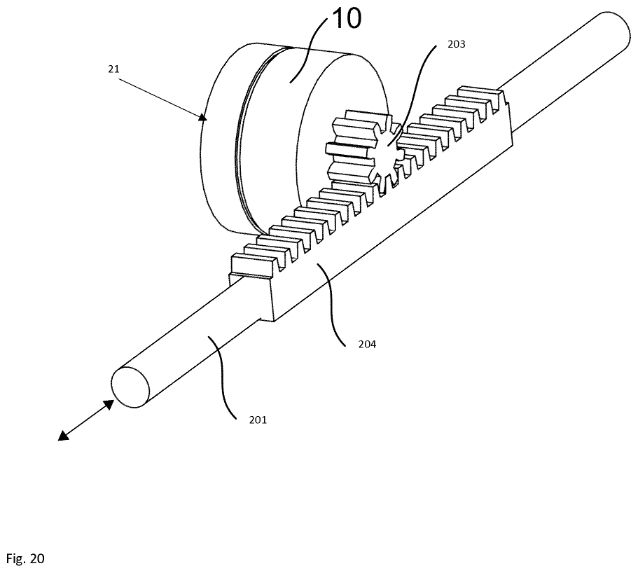

FIG. 20 shows a system with single motor 21 and single MR fluid clutch apparatus 10. A single MR fluid clutch apparatus 10 is used with a pinion 203 on the structural link 201, acting as a MR fluid brake by providing braking of the movement of the structural link 201 in the unbiased direction by applying a force on rack portion 204. The motor 21 may be a bi-directional motor in an embodiment.

FIG. 21 is a graph showing the condition of a reversal event, a.k.a., change or switch in direction for the output of the system, in a MR fluid motion control system (e.g., CW to CCW or vice versa, X translation to −X translation or vice versa). For example, an arrangement includes motor 21, optional input reduction mechanism 84, and MR fluid clutch apparatus 10 where the input member 12 spins at a different speed than the output member 11 to provide a slipping condition decoupling the input inertia from the output. The slip direction within the MR fluid clutch apparatus 10 controls the direction of the transmitted output torque (positive or negative). Undesired slip direction reversal may happen when the MR fluid clutch apparatus 10 slip changes direction, such as: A) when the input member 12 initially spins faster than the output member 11 and transitions to a state where it spins slower than the output member 11, reversing from a positive torque to a negative torque; B) when the input member 12 initially spins slower than the output member 11 and transitions to a state where it spins faster than the output member 11, reversing from a negative torque to a positive torque.

Live shifting the slip direction may allow a controller to maximise torque output and controllability. In the case of an arrangement featuring two motors 21 and two MR fluid clutch apparatuses, such as in FIGS. 18a and 19, it may mean that only one MR fluid actuator unit 20 (i.e., a branch of one motor 21 and one MR fluid clutch apparatus 10) is reversing in order to switch from collaborative slip (where the two branches of the arrangement may add torque to the output) to antagonistic slip mode (where the two branches apply torque in opposite directions on the output). This is explained in the patent application No. WO2021155478A1, incorporated herein by reference. This live shifting mode of a MR fluid actuator requires one of the clutch input speed members 12 or 12′, ω_{c,1} or ω_{c,2}, to either increase or decrease in order to switch side with respect to output speed, ωₐ (see FIG. 18a). In this example, both output members 11 and 11′ may turn at the same speed because if both output reduction mechanisms 86 and 86′ have the same mechanical ratio. Different ratios are however possible and hence ωₐ and ω_{ab} would be introduced in the equations. Controllability can potentially be lost during shifting, if shifting is too slow.

The speed difference during a reversal may be represented by ω_{c,2}-ω_{c,1}=2Δω assuming Δω slip is required within the MR fluid clutch apparatus 10 to produce a torque in the direction of Δω.

Assuming constant acceleration and neglecting motor electrical response, the slip reversal time may be limited by the gearmotor acceleration

$$( {α}_{g m} = \frac{{T}_{g m}}{{I}_{g m}} )$$

$$Δt = \frac{2 Δ ω}{{α}_{g m}}$$

For reversals to be perceptible, motor reversal times required may be smaller than the actuator's required torque time response:

Δt<<τᵣ

where the actuator's time response is related to the (−3 dB desired force command of the application) actuator's blocked force bandwidth in Hz by:

$${τ}_{r} = \frac{0.35}{{f}_{3 dB}}$$

Minimal gearmotor acceleration is thus needed for imperceptible slip shifts of given application:

$${α}_{g m} ≫ 5.7 Δ ω {f}_{3 dB}$$

If Δω=10i (in RPM, or Δω=1.05i in rad/s), and if the maximum humanly perceptible force bandwidth is 20 Hz, than the gearmotor's acceleration may be

$${α}_{gm} ≫ 7000 \frac{r a d}{{s}^{2}} .$$

For imperceptible shifts, shifts may be done in the constant torque regime where acceleration is at a maximum. Moreover, input reduction ratio 84 may be maintained as low as possible since

$${α}_{g m} = {α}_{m} \cdot \frac{1}{{r}_{p}} .$$

Hence motor/input reduction ratio 84 selection is critical for seamless slip direction change. For example, the torque-to-inertia ratio of a given motor 4rad/s² drops to 2rad/s² when coupled with a rₚ=4:1 input reduction ratio 84 and may become perceptible. In contrast, the other motor may be operated with input reduction ratio 84 rₚ=1:1 and have torque-to-inertia ratios in the

$$∼ 160 \frac{r a d}{{s}^{2}}$$

range, thus having strong potential for seamless shifts. The numbers used here are only provided for general illustration purposes and may not necessarily reflect real devices values.

As shown by the example, minimum gearmotor dynamics cannot always match system requirements. Antagonistic MR fluid systems using two counter-rotating MR fluid clutch apparatuses 10A and 10B like the one of FIG. 4 that are supposed to remain antagonistic may exhibit less reversal events since one MR fluid clutch apparatus 10 may supposedly be in slip condition in each direction in relation to the output, therefore providing optimal motion control performance. Such antagonistic MR fluid systems may not exhibit reversals events in some conditions. Nevertheless, it may be advantageous to design systems that may allow reversal in order to limit weight and cost of such systems. It may also be advantageous to design antagonistic MR fluid systems with some acceleration limitation in the two counter-rotating MR fluid actuator units and/or MR fluid clutch apparatuses in order to limit the power consumption of such systems. This may be interesting for a haptic device, like a force feedback aircraft inceptor, using a single motor connected to two antagonistic clutches, and where there is a need to limit the system weight, hence using a light motor connected to MR fluid clutches apparatus 10 and 10′ through a high ratio input gearbox 22, in spite of the fact that such a system may not present all optimal capabilities in terms of acceleration because of the relatively high reflected inertia of the motor at the input member 12 of the MR fluid clutch apparatus 10. In such system, a human may move faster than the haptic device capability to accelerate and the desired slip condition may reverse and reach a condition that is undesired from the force direction perspective. In another condition, the speed of the human may be faster than the maximum speed capability of the haptic device and slip reversal may also happen.

Motion control systems using only one motor 21 and one MR fluid clutch apparatus 10 like the one of FIG. 20, and reconfigurable motion control systems using multiples motor/MR fluid clutch chains that can switch between antagonistic operation and combined operation, like the one of FIG. 18a, may inevitably face reversal events, and are thus potentially impeded by the combination of motor 21 and input reduction mechanism 84 dynamics.

In a variant, the present disclosure describes a method for minimizing controllability losses during reversals when the dynamics of a combination of motor 21 and input reduction mechanism 84 are slower than motion system requirements.

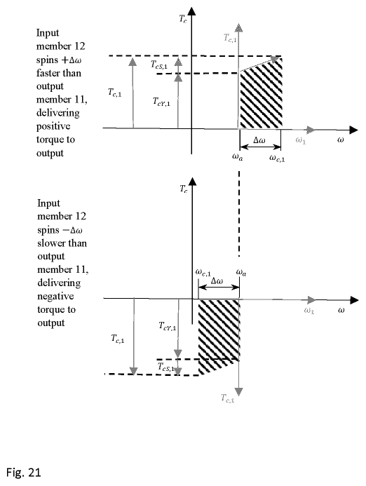

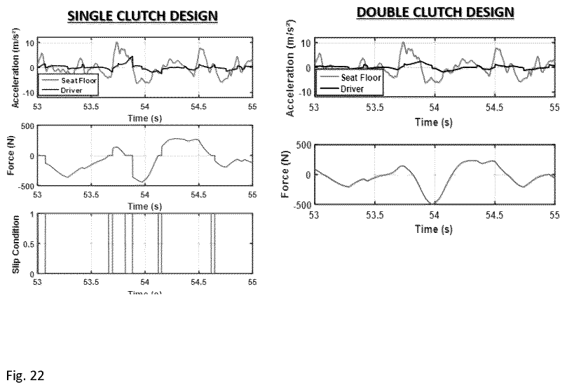

FIG. 22 is a graph showing limitations of the single motor single clutch active suspension system as in FIG. 3 versus the double clutch system of FIG. 4 or FIG. 5. Electromechanical actuators like the one of FIG. 20 consists of an electric motor 21 attached to a reduction mechanism and a rotation-to-translation transformation mechanism, e.g., linkages, rack and pinion or ball screw, etc. If a low reduction ratio is chosen, the parasitic forces are low, but the electric motor 21 must be bulky and heavy to produce the required torque. Alternatively, if a high reduction ratio is chosen, the motor 21 and reduction system can be light and compact, but the parasitic forces may be high. Since volume and mass must be minimized in the automotive industry, electromechanical actuators on the market may be highly geared, i.e., have a higher reduction ratio. To deal with the high parasitic reaction forces, manufacturers may resort to using a serial elastic element between the actuator and the wheel, in the case of vehicles for example. This reduces the parasitic forces and prevents the actuator from exhibiting high internal reaction loads during an impact, but it also reduces the force bandwidth of the actuator. That is why rotational electromechanical actuators typically exhibit slow reactiveness (<10 Hz). This may limit their performance potential. By combining a highly reactive device like a MR fluid clutch apparatus 10 with a highly gear power train that is torque and power dense, it may be possible to obtain a system that is at the same time torque and power dense, has low back-driving forces and is fast acting. Such systems are described in International patent application publication no. WO 2016/187719, incorporated herein by reference.

When controlling a single motor single clutch system, such as that of FIG. 20, in which the MR fluid clutch apparatus 10 filters out the high inertia of the motor 21 and gear train composed of the pinion 203 and the rack 204 and transmits a force in the proper direction, the MR fluid clutch apparatus 10 may need to be maintained in slippage. The input 14 of the MR fluid clutch apparatus 10 needs to turn faster than the output 11 of the MR fluid clutch apparatus 10. Hence, the motor 21 always has to maintain the slippage in the appropriate direction in order for the actuator to produce the corresponding force in the desired direction. When driving on the road, it may be difficult to predict or anticipate all obstacles that will influence the output of the active suspension that includes the MR fluid clutch apparatus 10. Occasionally, the motor 21 is not able to maintain the correct amount of slippage in the MR fluid clutch apparatus 10. For example, an obstacle (e.g. bump, hole, . . . ) may accelerate the output 201 of the active suspension at a higher rate than what is possible with the highly geared powertrain. This may be due to the low bandwidth, high inertia and/or limited torque of the highly geared power source of the motor 21 and input reduction mechanism 84 (e.g., gearbox, belt system), notably during a change of direction of rotation of the motor 21, if bi-directional. Furthermore, designers may want to limit motor reversal acceleration torque to lessen strut component weight. In such a scenario, the output 11 of the MR fluid clutch apparatus 10 may spin faster than the input 14 of the MR fluid clutch apparatus 10, and thus the MR fluid clutch apparatus 10 may entrain the motor 21 in the wrong direction and further delay the change of direction of the motor 21. Stated differently, in the case of such a reversal, the direction of the force applied by the MR fluid clutch apparatus 10 onto the motor 21 will also reverse before the motor 21 has changed direction, and will be in the opposite direction than the commanded force. On the left graphic of FIG. 22, this may happen when the slip condition goes to 0, slip condition of 1 being for the correct direction. When this happens, in order to minimize the commanded force vs the obtained or measured force, it may present an advantage to stop torque transmission by the MR fluid clutch apparatus 10. In order to do this, the MR fluid clutch apparatus 10 is controlled to provide zero torque. Different approaches may be taken for this, such as shutting down the MR fluid clutch apparatus 10, maintaining high slippage for a delayed period, delaying the reaction of the MR fluid clutch apparatus 10 to a frequency similar to that of the motor 21, switching the control of the MR fluid clutch apparatus 10 into a passive damper. This is the opposite of the other active suspension system where in order to minimize the delta between the desired force and the measured one, it may be required to increase the power of the system to a maximum. This specific function of the active MR fluid suspension system may be referred to as the let-go function. The effect of this let-go function may be seen on the force graphic on the left side of FIG. 22 where the force command of the MR fluid clutch apparatus 10 force is shown to 0 when a slip condition is reversed (equal 0). On a double MR fluid clutch apparatus system where the motor 21 does not have to reverse its direction (e.g., the motor 21 may be unidirectional), in order to provide torque in the correct direction, higher slip may be maintained in the MR fluid clutch apparatus 10 and a zero torque may be less likely to happen. In the example shown of a system having a double MR fluid clutch apparatus configuration, the higher slip condition between the input 14 of the MR fluid clutch apparatus 10 and the output member 11 may ensure that there is no inversion. The situation is worsened in the case of the single motor single clutch system because a lower slip is desirable in order to decrease the time the motor will take to switch from one direction to the other. For example, with a 10 to 1 reduction ratio 84 between the motor 21 and the MR fluid clutch apparatus 10, in order to maintain 200 RPM slip in the MR fluid clutch apparatus 10, the motor 21 needs to turn at 2000 RPM. To keep the 200 RPM of slip in the MR fluid clutch apparatus 10 when a force direction change is desired, the motor has to overcome the inertia generated by the motor 21 and go from 2000 RPM to −2000 RPM. To increase the mechanical bandwidth of such a single motor single clutch system, it may present an advantage to limit the slip in the MR fluid clutch apparatus 10. When doing so, there is an increase in the probability that the road will cause an acceleration of the output member 11 greater than the input member 14's capacity to accelerate as driven by the motor 21, so the let-go function may be useful more often than with the double clutch system for which a bigger slip may be maintained due to the fact that the motor 21 may not have to reverse its direction in a double clutch system. Anticipating the road perturbations with pre-visualisation techniques (e.g., LIDAR) or road digitizing may help to reduce the number of events where the let-go function may be used because slip rate may be increased in the correct direction before a planned event in order for the system to have enough slip within the MR fluid clutch apparatus 10 to cope with the situation to come. However, the let-go function may still be used when an obstacle provides larger speed of movement than the MR fluid actuator design maximum designed speed. The let-go function may still help keeping the maximum speed of the system to a level that allow the MR fluid actuator to stay within acceptable weight and size constraints.

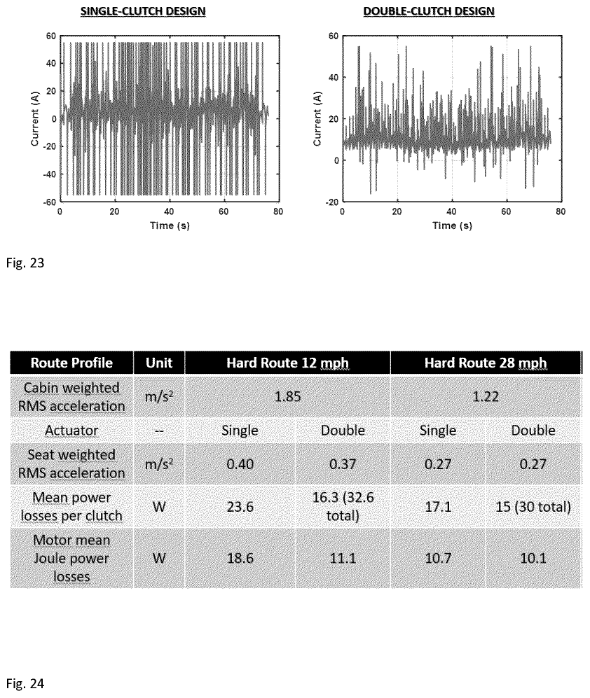

FIG. 23 shows graphs of a typical motor 21 current for a single motor single clutch active suspension versus a single motor double clutch suspension over the same cabin floor perturbation, in the embodiment of FIG. 6 as an example. The drawback of the single motor single clutch system may be that the motor 21 has to change its direction very often, such as many times per second. This high switching frequency may require large current demand for the motor 21 to switch direction rapidly. A single motor single clutch system may consequently consume more average energy than a double clutch system, in some circumstances. The use of the let-go function may reduce the current demand.

Therefore, a system for operating a magnetorherological (MR) actuator unit between bodies, such as in FIG. 20, may include a MR fluid actuator unit including a bi-directional motor assembly, the bi-directional motor assembly operating within a first frequency range, and a MR fluid clutch apparatus connected to the bi-directional motor assembly to apply a variable amount of force from the bi-directional motor between at least two of the bodies, the MR fluid clutch apparatus operating within a second frequency range, the second frequency range being higher than the first frequency range. Sensor(s) provide data indicative of a state of the body or bodies. The controller of the system may therefore perform actions such as: receiving the data from the sensor(s); determining from the data that the bi-directional motor assembly has to accelerate or decelerate to control an amplitude and direction of a relative speed between input and output of the MR fluid clutch apparatus to transmit a desired force between the bodies; controlling the bi-directional motor to accelerate or decelerate toward the given value at the first frequency range, and concurrently reducing a torque transmission from the MR fluid clutch apparatus during a lag period in which the torque transmission acts opposite to the desired force.

Because the MR fluid clutch apparatus 10 generally operates at a frequency range that is higher than a frequency range of the bi-directional motor assembly (e.g., including motor 21 and a reduction mechanism 84, notably because of inertia, backlash, etc), in some situations force transmission may be opposite (i.e., contrary) to a desired force transmission on the output 11. For example, in response to perturbations to which the system is exposed, the controller may determine that the motor assembly must accelerate or decelerate to a given value (e.g., to a greater or lesser speed), or reverse directions of rotation. The motor assembly is then controlled to accelerate or decelerate to the given value, but can only do so at its frequency range, lesser than the frequency range of the MR fluid clutch apparatus 10. The MR fluid clutch apparatus 10, transmitting force between input 12 (i.e., the motor 21) and an output 11, may thus react quicker than the motor 21. In such a scenario, it may be possible that the torque transmission by the MR fluid clutch apparatus 10 result in an improper slip direction during a lag period, i.e., the output 11 would act against the input 12 in the opposite direction than the desired one. Accordingly, the controller may reduce a torque transmission from the MR fluid clutch apparatus during this lag period in which the torque transmission acts opposite to the desired force, for example to compensate for the mismatch in frequency ranges of operation.

FIG. 24 shows an exemplary complete consumption of a single motor single clutch system. The motor 21 consumption of the single motor single clutch system may often be higher than the one of the double clutch systems. However, all the losses in the MR fluid clutch apparatuses 10 (and 10′ for the double clutch system) are taken into account, the overall power consumption of the single motor single clutch system may be lower, as it is the case for both shown conditions of FIG. 24. The platform vibration level of the single motor single clutch system may also not differ substantially from that of the double clutch system. There may be an advantage to having a single motor single clutch system integrated in an active suspension, despite the high number of motor direction changes that may be required, in order to reduce the energy consumption of the active suspension system. This may be important for any application that is running on batteries, like active suspension of electric cars.

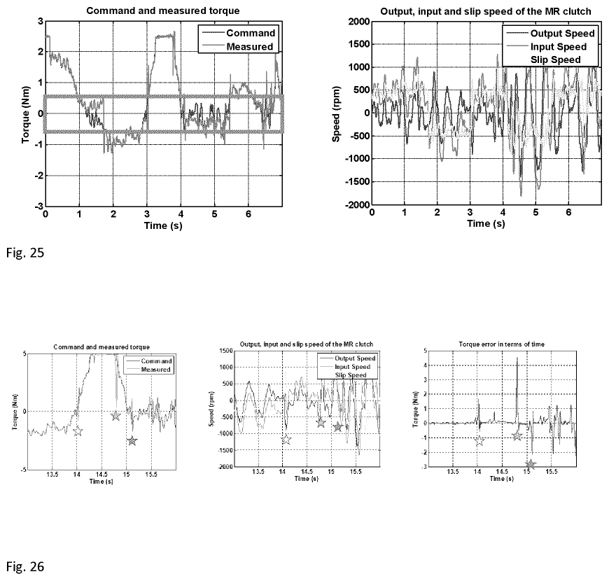

FIG. 25 shows the “keep slip” function of the single motor single clutch system of FIG. 20. When a single motor single clutch system is used, the high number of motor reversals may introduce a noise and vibration in the mechanical system. Noise and vibrations may come from high acceleration and deceleration reaction forces of the electric motor and/or from the backlash of the mechanical system. This may be called noise vibration and harshness (NVH) and it may be perceivable for the human being surrounding the system, such that it may be desired to reduce NVH. A novel way to minimize NVH for an active suspension using a single MR fluid clutch apparatus, is to limit the number of MR fluid actuator slip reversals. In order to limit MR fluid actuator slip reversals, a “keep slip” zone may be operated by the controller of the active suspension. This “Keep slip” zone may maintain the slip direction generated by the motor 21 between the input member 14 versus the output member 11 in the wrong direction for a limited period of time instead of operating the MR fluid clutch apparatus 10 to transmit the torque commanded. This “Keep slip” zone may be defined inside a force command, an input speed command and/or an output speed command amplitude. In other word, the slip direction within the MR fluid clutch apparatus 10 will not be instantly performed when it would be desired for optimal performance, it would be lagged. In this zone, this lag may be required in order to limit the number of reversals of slip direction within the MR fluid clutch apparatus 10 and to decrease reversals harshness. Fewer load reversals within the MR fluid clutch apparatus 10 will generate fewer force direction changes and hence fewer NVH. This lag function may however introduce a higher number of torque errors and its usage may be counter-intuitive when the target of an active suspension is to achieve the best vibrations and movement reductions. In spite of this, during the implementation, it may still present an advantage to decrease the performance of the active suspension system in order to decrease the harshness created, hence providing a better overall experience for the human surrounding the system, inside or outside the vehicle, even is a lower vibration and movement reduction is achieved by the active suspension.

The “Keep slip” function is illustrated in FIG. 25 where the slip is latched on one side in a deliberate lag until the commanded torque is getting superior to a given value in the opposite direction. This is only one control algorithm and other control algorithms may be used to control the lag and limit the number of reversals (e.g. Model Predictive Control (MPC, AI, pre-visualization of the obstacle with a camera only to name a few). In FIG. 25, the keep slip zone is shown to be around from −0.5 Nm to 0.5 Nm, but this value is not fixed for a given active suspension system. The value of the “Keep slip” zone may be dynamically adjusted in function of the operating conditions of the active suspension system.

According to a variant, the “Keep slip” function may be operated by a system for operating a suspension between a mass and a structure that may include a bi-directional motor such as 21; a magnetorherological (MR) fluid clutch apparatus such as 10 coupling the bi-directional motor 21 to the mass to apply force from the bi-directional motor to the mass. This may be in a single clutch, single motor arrangement. Sensor(s) provide data indicative of a state of the mass and/or of the structure. A controller of the system may have a processing unit; and a non-transitory computer-readable memory communicatively coupled to the processing unit and comprising computer-readable program instructions executable by the processing unit for: receiving the data from the sensor(s); determining from the data a required torque amplitude to be generated by the bi-directional motor; keeping the bi-directional motor off if the required torque amplitude is below a torque amplitude threshold, and activating the bi-directional motor if the required torque amplitude is above a torque amplitude threshold.

The lag function and value introduced in the “keep slip” function allows to minimize penalty force tracking ability of the active suspension while maintaining NVH at an acceptable level when the system is inside the keep slip zone. It may be useful for a single motor single clutch system similar to the one of FIG. 20 or for two motors two MR fluid clutches apparatus like the one of FIG. 15, 16, 18 or 19. The reversal of slip direction in the MR fluid clutch apparatus 10 for a single motor single clutch system of from MR fluid clutch apparatuses 10 or 10′ of a double motor double clutch system may requires one of the MR fluid clutch apparatuses 10 or 10′ input member 12 speed, ω_{c,1} or ω_{c,2}, to either increase or decrease in order to reverse slip direction with respect to output speed member 11 or 11′ that are both rotating at the same speed ωₐ because connected to each other. Controllability may potentially be lost during reversal if the time to reverse is too slow.

FIG. 26 shows the combination of the “let-go” function and the “Keep-slip” function of the single motor single clutch system of FIG. 20, though these functions may be operated independently, i.e., one without the other. The “Keep slip” function may increase the number of occurrences that the “let go” function will be used because it will increase the chances that the motor will turn in the opposite direction when an outside perturbation accelerates the output of the active suspension system faster than the input. It is shown at time 14.0, 14.8 and 15.1. In spite of this, there is a strong benefit of using the combination of both the “let-go” function and the “keep-slip” function because a single motor single clutch system may be implemented at a lower cost than a double clutch system and that the amount of NVH is maintained at an acceptable level, despite the fact that the performance of the active suspension is not to its maximum.

During driving, it may be an advantage for the user to select the level of “keep slip” function. In normal driving, it may be maintained to an acceptable level to limit the NVH and in more aggressive driving, a pilot could decide to completely turn it off in order to reach the maximum performance of the active suspension system, despite the increased level of NVH generated. For example, on gravel roads, where the noise level is high due to friction between loose material and the tire, it may be desirable to turn the “keep slip” function off, notably due to the potential increased frequency of active suspension interventions on such roads.

The single motor single clutch system may be used as an active suspension system but may also be used as an energy harvesting suspension only. The active suspension may then be qualified as semi-active as no energy is injected in the active quadrants (see FIG. 9) and only energy is dissipated, with energy recuperation or not, in the passive quadrants.

When systems featuring multiple MR fluid clutch apparatuses 10 are used, like the ones shown on FIGS. 4, 5, 15, 16a, 18a, 19, the same logic may be applied as with the single MR fluid clutch apparatus 10 system that is shown in FIGS. 3 and 20. In those systems with multiple MR fluid clutch apparatuses 10, it may occur that minimum gearmotor dynamics cannot always match system requirements. In such antagonistic MR fluid systems using two counter-rotating MR fluid actuator units, in some conditions, the two MR fluid clutch apparatuses 10 may not always remain antagonistic. One MR fluid clutch apparatus 10 may exhibit reversal events, resulting in both MR fluid clutch apparatuses 10 slipping in the same direction in relation to the output, therefore not providing optimal motion control performance. In such conditions, it may be useful to use the let-go function and the keep slip function to improve system behavior and to reduce NVH or non desired forces. This kind of condition may be caused by the lack of capacity of one of the motors to produce the optimal desired acceleration. This kind of condition may also be caused by imposed limitations to the motor or motors acceleration in order to limit the power consumption or peak power of the MR fluid actuator. It is known that high motor acceleration may require high current in the motor coil windings. Since joule losses in the coil windings of a motor is to the square of the current, it will be understood that limiting the current in the coil windings will also limit the Joules losses, hence the power consumption of the device as well as the heat generated in the device. It is to be noted that those Joule losses may in some cases not even produce usable work at the actuator output. If for example the system is excited while the commanded force is zero, the motor or motors may still have to track the output speed in order to maintain the ability of the actuator to generate a force in the right direction when required. Just this tracking alone from the motor or motors may require high acceleration and power from the motor or motor, hence it may be beneficial to limit the acceleration of the motor or motors. Limiting the current may target power consumption limitation, heat generation or both. The previous explanation is also valid for other configurations, like the one shown in FIGS. 16b and 18b, where one MR fluid clutch apparatus 10 is connected to a motor and where the other MR fluid clutch apparatus 10′ is grounded on the chassis to act as a brake. In such configurations, it may also happen that minimum gearmotor dynamics cannot always match system output requirements. Thus it may be possible for a controller of the systems with multiple MR fluid clutch apparatuses 10 to operate a let-go function and/or a keep-slip function.

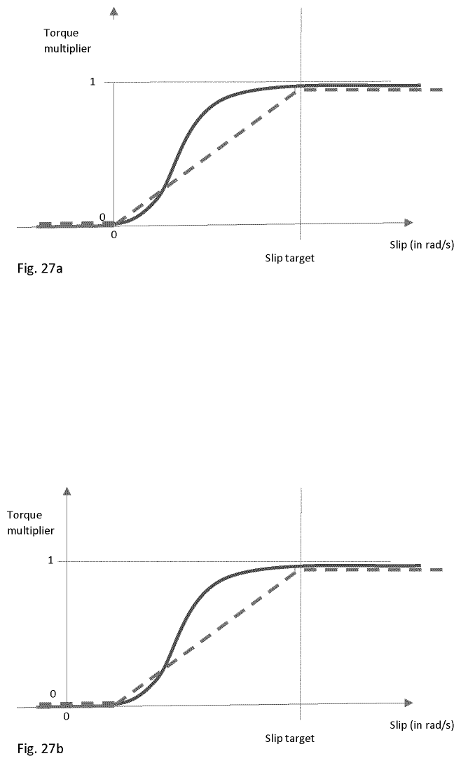

In any of the presented configurations, it may present an advantage to use the let-go function some time before a slip reversal situation physically occurs. This may help the system to cope with an event that may happen faster than the mechanical bandwidth of a MR fluid clutch apparatus 10. It may also be useful in case an event happens or could happen at a rate that is faster than the calculation speed of the controller 64. For example, if the acceleration of the output member 11 or any other component of the output of the MR fluid actuator is measured to be superior to the reaction capability of the MR fluid clutch apparatus 10 or controller 64, it may present an advantage to reduce the torque of the MR fluid clutch apparatus 10 some time before the slip reversal occurs in order to reduce the risk of a torque reversal. It may also be desired to reduce the risk of having an instantaneous torque cut-off (torque going from a given torque to 0) that could create NVH. In some situations, it may be advantageous for the torque reduction to be controlled linearly or non-linearly in relation to measured or calculated parameters, including the measured or calculated slip between the input member 12 and output member 11 of the MR fluid clutch apparatus 10. Such linear function and non-linear function are shown in FIG. 27a only for illustration purposes. As long as the slip target is meet, the system may supply the optimal calculated torque illustrated here by a torque multiplier of 1. When the slip target is below the threshold, the torque command or multiplier is gradually reduced in order to reach 0 when there is no more slip in the MR fluid clutch apparatus. The commanded torque stays at zero as long as there is a slip present in the MR fluid clutch apparatus in the opposite direction than the one desired. In FIG. 27b, a zero command may be reached while the slip direction is still in the desired direction in order to ensure that a fast acceleration or a delay in the controller may not induce a force in an undesired direction. The shape of the linear or non-linear functions may be dynamically adapted during operation based on measured or calculated parameters.

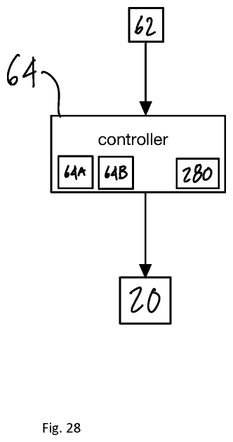

Referring to FIG. 28, the controller 64 is shown as having one or more processing units 64A, a non-transitory computer-readable memory 64B communicatively coupled to the processing unit and comprising computer-readable program instructions executable by the processing unit 64A for performing steps which are described above and are generally shown as 280 in FIG. 28, using data from sensors 62 associated with any one or more of the MR fluid actuators described herein. The controller 64 may drive any of the MR fluid clutch apparatuses 10 and/or drive the motors 21 thereof. For example, the controller 64 may be operated for: receiving the data from the at least one sensor; determining from the data that the motor assembly has to accelerate or decelerate to control an amplitude and direction of a relative speed between input and output of the MR fluid clutch apparatus to transmit a desired force between the bodies; controlling the motor assembly to accelerate or decelerate toward the given value at the first frequency range, and concurrently reducing a torque transmission from the MR fluid clutch apparatus during a lag period in which the torque transmission acts opposite to the desired force. In some variants, reducing the torque transmission includes turning the MR fluid clutch apparatus off; reducing the torque transmission includes delaying a response of the MR fluid clutch apparatus during the lag period; reducing the torque transmission includes delaying a response of the MR fluid clutch apparatus during the lag period when the system is held inside a pre-defined operating zone; determining from the data that the motor assembly has to accelerate or decelerate to control an amplitude includes controlling the direction of a relative speed between the input and the output of the MR fluid clutch apparatus to transmit the desired force between the bodies. In a variant, the lag period corresponds to a time duration during an absolute slip speed of the MR fluid clutch apparatus is smaller than a required slip threshold. The controller 64 may be used for determining from the data a required speed amplitude to be generated by the bi-directional motor; maintaining slippage in the MR fluid clutch apparatus to remain in a current direction and be unresponsive to the required slip speed amplitude reversal if the required absolute torque amplitude is within a torque amplitude threshold, and, reversing a slip speed of the MR fluid clutch apparatus if the required absolute torque amplitude is beyond the torque amplitude threshold in the opposite direction. The controller 64 may also be used for receiving the data from the at least one sensor; determining from the data that the bi-directional motor switches direction; concurrently controlling the bi-directional motor to reducing a torque transmission from the MR fluid clutch apparatus when the slip is not in the desired direction.

1. A system for operating a magnetorherological (MR) fluid actuator unit between bodies, comprising:
at least one MR fluid actuator unit including a motor assembly, the motor assembly operating within a first frequency range, and a MR fluid clutch apparatus connected to the motor assembly to apply a variable amount of force from the motor assembly between at least two of the bodies, the MR fluid clutch apparatus operating within a second frequency range, the second frequency range being higher than the first frequency range;
at least one sensor for providing data indicative of a state of at least one of the bodies;
a processing unit; and
a non-transitory computer-readable memory communicatively coupled to the processing unit and comprising computer-readable program instructions executable by the processing unit for:
receiving the data from the at least one sensor;
determining from the data that the motor assembly has to accelerate or decelerate to control an amplitude and direction of a relative speed between input and output of the MR fluid clutch apparatus to transmit a desired force between the bodies;
controlling the motor assembly to accelerate or decelerate toward the given value at the first frequency range, and
concurrently reducing a torque transmission from the MR fluid clutch apparatus during a lag period in which the torque transmission acts opposite to the desired force.

2. The system according to claim 1, wherein the motor assembly includes a motor and a reduction mechanism.

3. The system according to claim 1, wherein reducing the torque transmission includes turning the MR fluid clutch apparatus off.

4. The system according to claim 1, wherein reducing the torque transmission includes delaying a response of the MR fluid clutch apparatus during the lag period.

5. The system according to claim 1, wherein reducing the torque transmission includes delaying a response of the MR fluid clutch apparatus during the lag period when the system is held inside a pre-defined operating zone.

6. The system according to claim 1, wherein the motor assembly includes at least an unidirectional motor.

7. The system according to claim 1, wherein the motor assembly includes at least a bi-directional motor.

8. The system according to claim 7, wherein determining from the data that the motor assembly has to accelerate or decelerate to control an amplitude includes controlling the direction of a relative speed between the input and the output of the MR fluid clutch apparatus to transmit the desired force between the bodies.

9. The system according to claim 7, including two of the MR fluid actuator unit, each said MR actuator unit having a bi-directional motor connected to a respective one of the MR fluid clutch apparatus, the two MR fluid actuator units controlling the desired force on a common output.

10. The system according to claim 1, wherein a first of the bodies is a mass and a second of the bodies is a structure.

11. The system according to claim 10 wherein the structure is sprung from the mass.

12. The system according to claim 1, wherein the system is an active suspension generating energy in passive quadrants.

13. The system according to claim 1, wherein the system is an active suspension using energy in the active quadrants.

14. The system according to claim 1, wherein the bodies are links of a robot.

15. The system according to claim 14, wherein the robot is a collaborative robot.

16. The system according to claim 1, wherein the bodies are a fixed chassis and a haptic device.

17. The system according to claim 1, wherein the lag period corresponds to a time duration during an absolute slip speed of the MR fluid clutch apparatus is smaller than a required slip threshold.

18. The system according to claim 7, including determining from the data a required speed amplitude to be generated by the bi-directional motor; maintaining slippage in the MR fluid clutch apparatus to remain in a current direction and be unresponsive to the required slip speed amplitude reversal if the required absolute torque amplitude is within a torque amplitude threshold, and, reversing a slip speed of the MR fluid clutch apparatus if the required absolute torque amplitude is beyond the torque amplitude threshold in the opposite direction.

19. A system for operating a suspension between a mass and a structure, comprising:
a bi-directional motor;
a magnetorherological (MR) fluid clutch apparatus coupling the bi-directional motor to the mass to apply force from the bi-directional motor to the mass;
at least one sensor for providing data indicative of a state of the mass and/or of the structure; a processing unit; and
a non-transitory computer-readable memory communicatively coupled to the processing unit and comprising computer-readable program instructions executable by the processing unit for:
receiving the data from the at least one sensor;
determining from the data a required speed amplitude to be generated by the bi-directional motor;
maintaining slippage in the MR fluid clutch apparatus to remain in a current direction and be unresponsive to the required slip speed amplitude reversal if the required absolute torque amplitude is within a torque amplitude threshold, and,
reversing a slip speed of the MR fluid clutch apparatus if the required absolute torque amplitude is beyond the torque amplitude threshold in the opposite direction.

20. A system for operating a suspension between a mass and a structure, comprising:
a bi-directional motor, the bi-directional motor operating within a first frequency range;
a magnetorherological (MR) fluid clutch apparatus coupling the bi-directional motor to the mass to apply force from the bi-directional motor to the mass, the MR fluid clutch apparatus operating within a second frequency range, the second frequency range being higher than the first frequency range;
at least one sensor for providing data indicative of a state of the mass and/or of the structure;
a processing unit; and
a non-transitory computer-readable memory communicatively coupled to the processing unit and comprising computer-readable program instructions executable by the processing unit for:
receiving the data from the at least one sensor;
determining from the data that the bi-directional motor switches direction;
concurrently controlling the bi-directional motor to reducing a torque transmission from the MR fluid clutch apparatus when the slip is not in the desired direction.
